(19) United States
(12) Patent Application Publication
(10) Pub. No.: US 2002/0005620 A1
(43) Pub. Date: Jan. 17, 2002

(54) Scooter for children

(76) Inventor: Sang Nam Han, Pusan (KR)

Correspondence Address: BIRCH STEWART KOLASCH & BIRCH, PO BOX 747, FALLS CHURCH, VA, 22040-0747, US

(21) Appl. No.: 09/756,857

(22) Filed: Jan. 10, 2001

(30) Foreign Application Priority Data
Jul. 12, 2000 (KR) 2000-19980

(51) Int. Cl. B62M 1/00

(52) U.S. Cl. 280/87.041; 280/11.28

(57) ABSTRACT

A scooter for children which includes a long footboard between two small end wheels and is controlled by an upright steering handle attached to the front wheel through a spring member for absorbing and reducing the impact generated from the front wheel so as to prevent a store of fatigue from accumulating, to maintain a fine figure thereof and lengthen the life thereof.

### BACKGROUND OF THE INVENTION

1. Field of the Invention

The present invention relates to a scooter for children and more particularly to a child's foot-operated vehicle consisting of a narrow board mounted between two wheels disposed in tandem with an upright steering handle attached to the front wheel for absorbing and reducing the impact generated from the front wheel during the operation of the vehicle.

2. Description of Related Art

Various types of scooters for children are known in the art. Generally, a scooter is a child's foot-operated vehicle which includes a narrow board, a front wheel, a rear wheel and an upright steering handle.

However, such a conventional scooter suffers from a number of problems. For example, since the conventional scooter includes a U-shaped supporting metal piece attached to the bottom of the upright steering handle and connects with the front wheel thereof, the impact generated from the front wheel during the operation of the device is transferred directly to the hands of the user through the handle thereof. Therefore, the user frequently suffers from operational fatigue and the scooter suffers from physical fatigue which affects its operation over a period of time.

### SUMMARY OF THE INVENTION

Accordingly, it is an object of the present invention to provide a scooter for children which eliminates the above problems encountered with conventional scooters.

Another object of the present invention is to provide a scooter for absorbing and reducing the impact generated in the front wheel during its operation.

A further object of the present invention is to provide a smooth scooter which includes a narrow board mounted between a front wheel and a rear wheel, an upright steering handle, and a spring member attached at one side to the bottom of the upright steering handle and at the other side to a U-shaped bracket which connects to the front wheel for eliminating the impact resulting from the operation of the scooter.

Still another object of the present invention is to provide a scooter for children which is simple in structure, inexpensive to manufacture, durable in use, refined in appearance and safe in operation.

Other objects and further scope of applicability of the present invention will become apparent from the detailed description given hereinafter. It should be understood, however, that the detailed description and specific examples, while indicating preferred embodiments of the invention, are given by way of illustration only, since various changes and modifications within the spirit and scope of the invention will become apparent to those skilled in the art from this detailed description.

Briefly described, the present invention is directed to a scooter for children which includes a long footboard disposed between front and rear wheels, with an upright steering handle attached to the front wheel through a spring member for reducing impact and vibration resulting from the operation of the scooter generated in the front wheel.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a scooter for children according to the present invention;

FIG. 2 is an exploded perspective view of a spring member used in the scooter according to the present invention;

FIG. 3 is a side-sectional view of a portion of the scooter according to the present invention; and

FIG. 4 is a front-sectional view of the scooter according to the present invention.

### DETAILED DESCRIPTION OF THE PREFERRED EMBODIMENTS

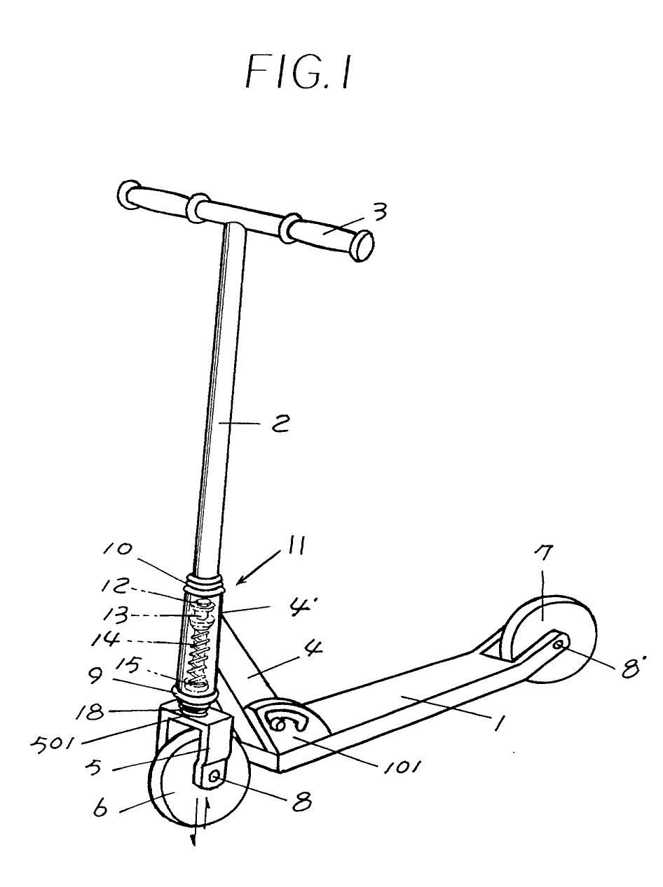

Referring now in detail to the drawings for the purpose of illustrating the preferred embodiments of the present invention, the scooter for children as shown in FIGS. 1, 2, 3 and 4 includes a narrow and long footboard 1 disposed between a front wheel 6 and a rear wheel 7 and controlled by an upright steering handle 3, an upright steering axle 2 connected to the handle 3, and a spring member 11 connected to the bottom of the steering axle 2 at the upper end thereof and at the lower end thereof to a U-shaped iron bracket 5 which is attached to the front wheel 6. A bolt 12 and a nut 17 are used to attach the spring to the bracket. The footboard 1 is provided with a supporting plate 101 for securely accommodating one foot of the user (FIG. 1).

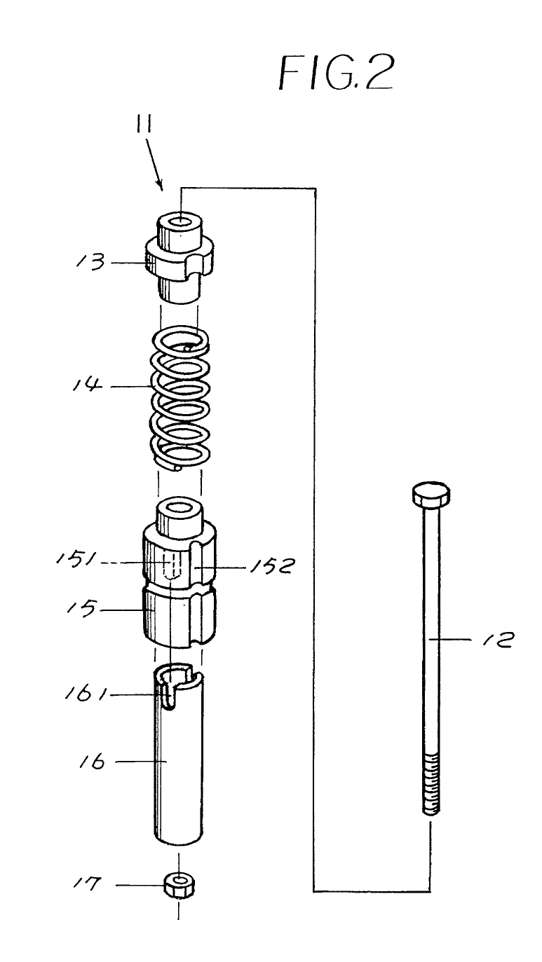

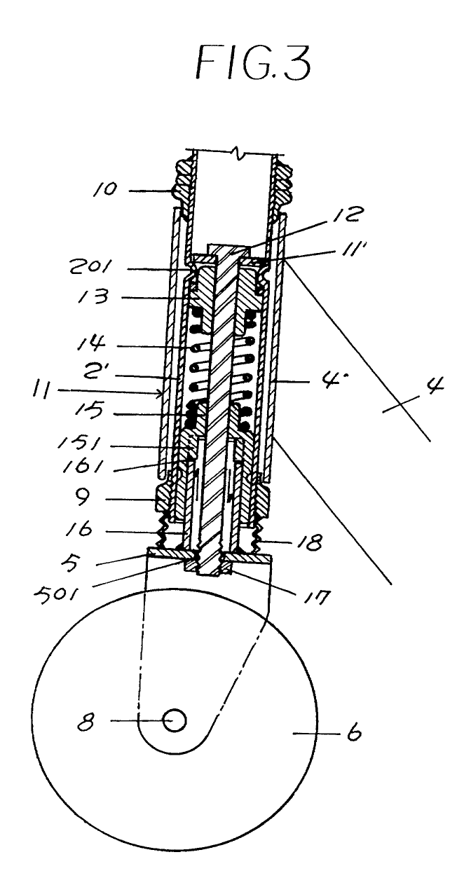

As shown in FIG. 2, the shock absorbing member 11 is a spring 14 disposed between an upper bushing 13 and a lower bushing 15, and a cylinder 16 having a pair of vertical slits 161 for receiving a vertically positional projection 151 disposed within the lower bushing 15. The spring member 11 is connected between an upper fixing ring 10 of the upright steering axle 2 and the bracket 5 through a lower fixing ring 9 utilizing the nut 17 as shown in FIG. 3. The spring can be replaced with other types of shock absorbing members, e.g., hydraulic cylinders, which are capable of performing similar functions as the spring.

Referring to FIG. 1, the long footboard 1 is connected to a supporting cylinder 4′ through a connecting plate 4. The iron bracket 5 has a U-shaped configuration for supporting the front wheel on a front wheel shaft 8. the rear wheel 7 is connected to the end of the footboard 1 by a rear wheel shaft 8′. The cylinder 16 is mounted to the top of the U-shaped iron bracket 5. The rear wheel 7 is supported by a rear wheel shaft 8′. The front wheel and the back wheel can include a plurality of wheels at each location.

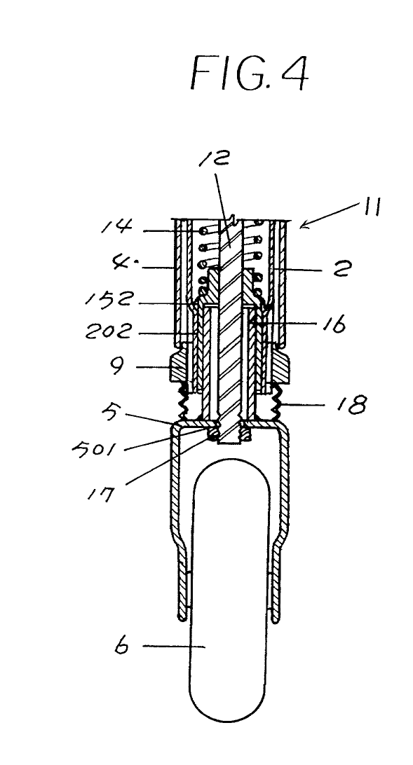

As shown in FIGS. 3 and 4, a projecting neck 201 which is an end part of the upright steering axle 2 is folded with an end axle 2 . The end axle 2′ has a vertical guiding protrusion 202 for slidably engaging with a vertical guiding groove 152 of the cylinder 16. Thus the spring 14 with the lower bushing 15 moves up and down for reducing and absorbing the impact from the front wheel 6. At this time, the vertical projection 151 is tightly engaged with the pair of slits 161 of the cylinder 16. Therefore, when exposed to significant impact, the front wheel 6 cannot rotate freely which prevents the causing of an accident.

The bolt 12 is provided with a washer 11′ which is inserted between a bolt head and the upper busing 13. The U-shaped iron bracket 5 is provided with an aperture 501 disposed on the top thereof for receiving the bolt 12, and a cover connected to the lower bushing 16.

As shown in FIGS. 1 and 4, the scooter for children according to the present invention operates as follows. When the user, for example, a child, holds the handle 3, and the one foot of the user pushes the ground while the other foot is placed on the footboard 1, the scooter moves forward quickly and smoothly. At this time, the bracket 5 is fixed to the upright steering axle 2, the upper bushing 13 is biased by the spring to prevent it from going up due to the projecting neck 201 and the protrusion 161 of the cylinder 16 welded on the top of the U-shaped iron bracket 5. Also, since the supporting cylinder 41 of the connecting plate 4 includes the upper and lower fixing rings 9 and 10 welded thereto, the end part of the steering axle 2 and the end steering axle 2′ cannot move up and down.

However, since the lower bushing 15 can freely move up and down along the vertical guiding protrusion 202 of the end steering axle 2′ due to the elasticity of the spring 1, when an impact or shock is generated in the front wheel 6, the impact is effectively absorbed or reduced by this movement of the lower bushing 15. Also, at this time since the vertical fixing projection 151 of the lower bushing 15 tightly engages with the pair of vertical slits 161 preventing the bracket 5 from rotating.

The scooter for children according to the present invention has a number of advantages. For example, since the impact can be eliminated or substantially reduced, the fatigue on the user and the scooter can be reduced.

The invention being thus described, it will be obvious that the same may be varied in many ways. Such variations are not to be regarded as a departure from the spirit and scope of the invention, and all such modifications as would be obvious to one skilled in the art are intended to be included in the scope of the following claims.

What is claimed is:

1. A scooter which comprises:
a footboard,
front and rear wheels attached to the footboard,
a bracket attached to the front wheels and a handle operatively connected to the bracket, wherein
a shock absorbing means is disposed between the handle and the bracket for absorbing any vibration or shock associated with the operation of the scooter.

2. The scooter of claim 1, wherein locking means are operatively associated with the spring means and the front wheels whereby upon the depression of the spring means beyond a predetermined amount, the rotation of the front wheel is prevented.

3. The scooter of claim 1, wherein the bracket has a substantially U-shaped configuration.

4. The scooter of claim 1, wherein the shock absorber means is a spring.

5. The scooter of claim 1, wherein the shock absorber means is a hydraulic cylinder.
